(19) United States
(12) Patent Application Publication
(10) Pub. No.: US 2006/0156414 A1
(43) Pub. Date: Jul. 13, 2006

(54) Increasing the extendibility of disk copy protection

(76) Inventors: Wenying You, Shanghai (CN); Bei Wang, Shanghai (CN); Gongming Wei, Shanghai (CN)

Correspondence Address: PHILIPS INTELLECTUAL PROPERTY & STANDARDS, P.O. BOX 3001, BRIARCLIFF MANOR, NY, 10510, US

(21) Appl. No.: 10/540,795

(22) PCT Filed: Dec. 29, 2003
(86) PCT No.: PCT/IB03/06244

§ 371 Date: Jan. 26, 2006

(30) Foreign Application Priority Data
Dec. 30, 2002 (CN) 02158391.9

(51) Int. Cl. H04L 9/32

(52) U.S. Cl. 726/27

(57) ABSTRACT

The present invention relates to a method for increasing the extendibility of disk copy protection and a system for the same. The method includes the following steps: a) Compare the version number in the system for disk copy protection with that of corresponding system for the copy protection in the player and confirm whether it needs to revoke data; b) If the data need to be revoked, read the information about the revocation data in said disk, then confirm whether to revoke the partial relevant playing license or revoke all the relevant playing license; c) If partial relevant playing license is to be revoked, undertake revoking confirmation. Using the method for increasing the extendibility of disk copy protection and the system for the same, it is very easy to upgrade the system for disk copy protection and player protection, thereby to prevent piracy effectively.

### FIELD OF THE INVENTION

The invention generally relates to a system for disk copy protection, and more particularly, to a method for increasing the extendibility of disk copy protection and a system for the same.

### BACKGROUND OF THE INVENTION

For any new optical disk (compact disc) standard, copy protection is a key factor for it to be accepted by the content industry. For a recordable disk, the copy protection system can exchange the information with the recorder so that it is easier to update the copy protection. strategies. But for the pre-recorded compact disc, it is not easy to do it in this way. Although the disk copy protection includes the method for revocation, the method for revocation can just revoke a limited number of illegal users and the premise is that the system hasn't been broken yet. Once the copy protection system is broken, no further method can be taken for remedying. For example, the DVD copy protection system CSS (Content Scrambling System) has once been treated as a powerful tool to prevent piracy. Once it is cracked by decryption software, the system doesn't work again. So, a remedying measure is very important to prevent the whole copy protection system from collapsing.

### SUMMARY OF THE INVENTION

The object of the present invention therefore seeks to provide a method for increasing the extendibility of compact disc copy protection and a system for the same. Using this method, it is very easy to upgrade the system for disk protection and player protection, thereby to prevent piracy effectively.

To achieve the object of the present invention, there is a method used in a player for increasing the extendibility of disk copy protection, including the following steps: a) Compare the version number in the system for disk copy protection with that of corresponding system for the copy protection in the player and confirm whether it is needed to revoke data; b) If the data is needed to be revoked, read the information on the revocation data in said compact disc, then confirm whether to revoke the partial relevant playing license or revoke all the relevant playing license; c) If the partial relevant playing license is to be revoked, undertake revoking confirmation.

According to another aspect of the present invention, we provide a player of increasing the extendibility of disk copy protection, which includes a drive part and a decoding part. Said drive part includes an authentication module, a bus encryption module and an ID confirmation module. Said decoding part includes an authentication module, a bus decryption module, a revocation confirmation module and an ID confirmation module. Wherein, when said player judges it needs to revoke all the relevant playing license according to the information of revocation data in said played compact disc, the ID confirmation module in said drive part, updating the software of the bus encryption module in the drive part, firstly confirms if the player holds legal authorization, if it holds, updates the software of the bus decryption module and updates the software of the bus decryption module and revocation confirmation module in the decoding part; when said player needs to implement the revoking partial relevant playing license, the revocation confirmation module in the decoding part receives revocation data read from the compact disc and confirms revoking partial revocation data.

Accordingly, using the method of the present invention for increasing the extendibility of disk copy protection and the system for the same, it is very easy to upgrade the system for disk protection and player protection, and thereby to prevent piracy effectively.

### BRIEF DESCRIPTION OF THE DRAWING FIGURES

The following will describe in detail the present invention with reference to the accompanying drawing figures wherein:

FIG. 1 is a schematic view of using the web system to upgrade the copy protection of the present invention;

FIG. 2 is a schematic view of using the special upgrading optical disk or floppy disk to upgrade the system for copy protection of the present invention; and

FIG. 3 is a flow chart of upgrading the system for copy protection of the present invention.

### DETAILED DESCRIPTION OF THE INVENTION

The idea of the present invention is as follows:
1. The player checks copy protection version. During setting up the copy protection system, both the disc and the player hold the version number of it. They have to match with each other. Each time the player plays the compact disc, it will test the version number of the compact disc;
2. The copy protection of the compact disc can be upgraded. If the copy protection version changes, the flag value also changes;
3. Once the system is broken, the player's copy protection system can be upgraded. The player should be upgraded in this way that it can still recognize the old copy protection system so that it can play all the old compact discs. For the new compact discs, it will own a new version of copy protection. The player can play both the new compact discs and the old compact discs;
4. There are several ways to extend the copy protection system on the player:

If the player can access the web site, it can download the software from the web site and flash the player to upgrade the copy protection system thereof. If the player can't access the web site, the special upgrading compact disc or floppy disk can be used to flash the player to upgrade the copy protection system thereof;

If the hardware chip for the copy protection part is affected, it needs to be replaced by a new hardware chip.

The specific embodiment of the present invention will be described in detail as follows.

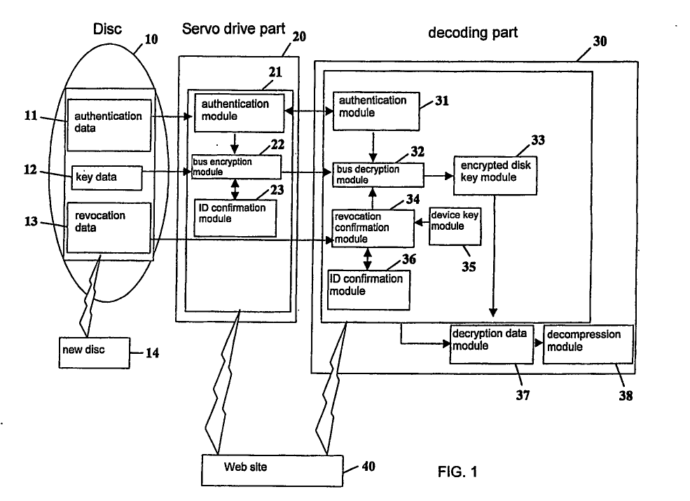

FIG. 1 is a schematic view of using the web system to upgrade the copy protection of the present invention. As shown in FIG. 1, the playing system generally includes a compact disc 10 and a player, and the player includes a servo drive part 20 and a decoding part 30. To extend the disk copy protection system, said compact disc 10 and said player need to be extended at the same time. As for the compact disc 10, the relevant contents of the copy protection system include an authentication data 11, a key data 12 and a revocation data 13. As shown in FIG. 1, said three data can be integral or individual. The relevant contents of the copy protection system in said servo drive part include an authentication module 21, a bus encryption module 22 and an ID confirmation module 23. The relevant contents of the copy protection system in said decoding part include an ID confirmation module 36, an authentication module 31, a bus decryption module 32, a revocation confirmation module 34.

When the old copy protection system is threatened, the newly issued compact disc must have new copy protection module. The newly issued compact disc is characterized in the change of version number to distinguish from the old one. The revocation data 13 and key data 12, which are set in the guiding area and data area of the compact disc respectively, are also refreshed. In the guiding area of the compact disc, there is a controlling data block including 192 ECCs (Error Correction), each of which includes 16 sectors. Table 1 shows the contents of the 16 sectors.

TABLE 1
Structure of a Data block

| Sector Number | Contents |
|---|---|
| 0 | Information on physical format |
| 1 | Information on disk manufacturing |
| 2 | Disk key sector |
| . . . | . . . |
| 15 | Information on the contents provider |

In the 16 sectors, each includes 2048 bytes. The second sector stores encrypted disk keys that are 16 bytes or over or less, depending on the actual copy protection system. Here, take 16 bytes of the encrypted disk keys as an example. Table 2 is the structure of the second sector. Before storing the disk keys, 16 bytes are used to store the information on the version number and padding byte “0×FF”. The rest bytes are empty for the present and set 0×00.

TABLE 2
Structure of the Second Sector

| Byte Address | Contents | Byte |
|---|---|---|
| 0-7 | Version number information | 8 |
| 8-15 | “0xFF” padding bytes | 8 |
| 16-31 | Encrypted disk keys | 16 |
| 32-2047 | Reserved | 2016 |

When the compact disc player reads the compact disc 14, it will firstly read the data in the guiding area, when it can check the information on version number and compare it with its own version number so as to judge whether updating is needed. If it is needed, read the information on revocation data 13 further, which is set in a system file of the header of data area and read it before playing the compact disc content. The revocation data 13 is divided into two categories, one is partial revocation, i.e. the revocation of part keys that have been disclosed. Said partial revocation is the revocation of illegal users data whose partial keys have been disclosed. The other is all the keys have been disclosed and all the players need to be updated, calling it as complete revocation.

Regarding the partial revocation, the firmware of the disk player doesn't need to be upgraded. The partial revocation can be implemented just by updating the compact disc because the player can gain the information from the compact disc. The servo drive part 20 of the player can transfer information from the compact disc to the decoding part 30, then the revocation confirmation module 34 will confirm and change the flag value of copy protection system. Therefore, the partial revocation can be accomplished without adopting special upgrading method.

As for the complete revocation, it must firstly revoke all the key data, that is to say, the users must update the disk player before reading newly issued compact disc, when the message “need to update the player before reading” is shown on the disk player.

The updating method of disk player for complete revocation will be described in detail as follows.

If the player has the function of accessing the network, it can access web site 40 to upgrade the copy protection system. The servo drive part 20 of the disk player can implement the bus encryption transmission. When in complete revocation, the firmware of the bus encryption module 22 needs updating, which can be implemented by downloading the corresponding new software from the special web site 40 when the player is on the status of stand-by. An authentication process is necessary before downloading the software to prevent the illegal player from downloading the new software. Every player has its own specific series number and ID before leaving factory. The users just know the series number, and the server will find its corresponding ID flag after encrypting it according to the series number. If this player shows the message of the player needing updating, the user can send the series number to the server of the appointed web site. The server will encrypt it and find the corresponding ID of the player according to the sent series number, then give the new software of the corresponding module of this player according to the ID. The users can thus download it. Before the new software is installed, it is also necessary to confirm whether it matches with the old software, that is to confirm whether the player has legal ID or not, which is implemented. by ID confirmation module 23 in the servo drive part 20. Only after matching can the firmware of servo drive part be updated.

As far as the complete revocation is concerned, the bus decryption module 32 and the revocation module 34 in the decoding part 30 also need updating. The users send their series number to the server of the appointed web site 40. The server will encrypt it and find the corresponding ID of the player according to the sent series number, then give the new software of the bus decryption module 32 and the revocation confirmation module 34 of the corresponding player. The users can thus download it. Before the new software is installed, it is also necessary to confirm whether it matches with the old software, which is implemented by ID confirmation module 36 in the decoding part. Only after matching can the bus decryption module 32 and the revocation module 34 in the decoding part be updated. And only when the copy protection system is updated can the player play the new compact disc with the other modules', such as the encrypted disk key module 33, the device key module 35, decryption data module 37 and decompression module 38.

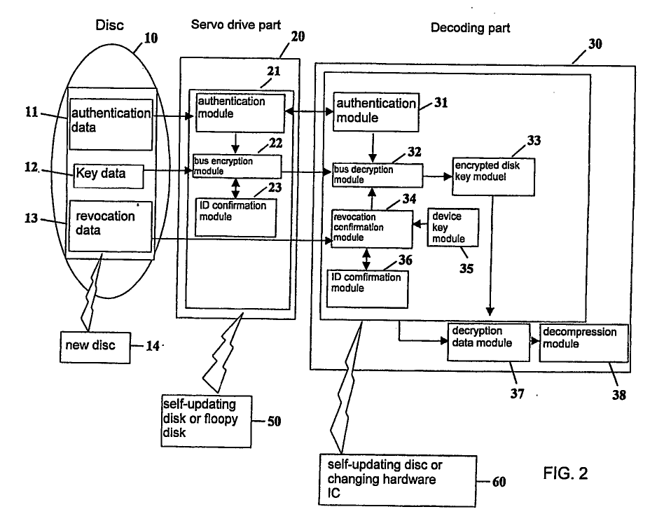

As for the player that has no function of connecting with the web site, its servo drive part and decoding part are updated and extended by different method. Refer to FIG. 2, FIG. 2 is a schematic view of using the special upgrading optical disk or floppy disk to upgrade the system for copy protection. We can understand from FIG. 2 that the updating of the servo drive part 20 depends on its own type. If it is a ROM driver, the updating of the drive software can be implemented by specifically made self-updating optical disk or floppy disk 50. If it is an Audio or Video driver, the drive software can be updated with the floppy disk provided by the provider by means of parallel interface or series interface. The chip of the driver made by Philips Co. has possessed such self-updating function, but the self-updating optical disk or floppy disk 50 must obtain the series number and the updating software provided by the provider corresponding to the player, and confirm its ID by the ID confirmation module 23 before it updates the software of the bus encryption module in the servo drive part 20. The decoding part 30 can also be updated by self-updating compact disc 60, which also must obtain the series number and the updating software provided by the provider corresponding to the player, and confirm its ID by the ID confirmation module 23 before it updates the software.

If the module involving copy protection in decoder part 30 is done with hardware, it needs to be replaced by a new hardware module or chip directly.

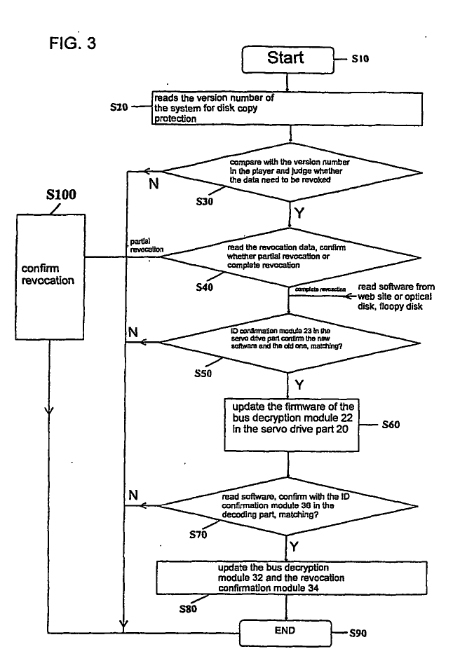

FIG. 3 is a flow chart of upgrading the system for copy protection of the present invention. As shown in FIG. 3, the process starts at step S10, put the compact disc 10 to the compact disc player. When the disk player reads the compact disc, it firstly reads the data in the guiding area, and reads the version number of the system for disk copy protection S20. Then compare it with the version number in the player and judge whether the data need to be revoked S30, if not, then end. If it needs to revoke the data, read the information on the revocation data 13 further. After reading the revocation data 13, confirm whether partial revocation or complete revocation S40. If revocation is partial revocation, the firmware of the disk player doesn't need to be updated. The partial revocation can be implemented just by updating the compact disc because the player can get the information from the compact disc, and the player servo drive part 20 can transfer it to the decoding part 30, then the revocation confirmation module 34 will confirm and change the flag value S100 of the copy protection system. Therefore, the partial revocation can be realized without adopting special method for upgrading. If revocation is complete revocation, the update can be implemented by ways of web site 40 or specific upgrading optical disk or floppy disk 50. The update thereof can be done when making it. So, as for the complete revocation, we can read the software from the web site or compact disc, and ID confirmation module 23 in the servo drive part implements matching confirmation of the new software and the old one S50. If not, it indicates that the user should not get the software. If matching, update the firmware of the bus encryption module 22 in the servo drive part 20, at step S60. After that, the bus decryption module 32 and revocation confirmation module 34 in the decoding part 30 also need updating. Before installing the new software, it must take the confirmation with the ID confirmation module 36 in the decoding part, at step S70. Only after matching each other, can the bus decryption module 32 and the revocation confirmation module 34 in the decoding part be updated, at step S80. If not, then end S90. After finishing the update of the copy protection system, the whole flow ends at step S90. Please note that it is just one embodiment of the update of the software, and the present invention is not limited to the update order.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art.

What is claimed is:

1. A method used in a player for increasing the extendibility of disk copy protection, it includes the following steps:
a) Compare the version number in the system for disk copy protection with that of corresponding system for the copy protection in the player and confirm whether it needs to revoke data;
b) If the data needs to be revoked, read the information on the revocation data in said disk, then confirm whether to revoke the partial relevant playing license or revoke all the relevant playing license in accordance with the information on the revocation data;
c) If the partial relevant playing license is to be revoked, undertake revoking confirmation.

2. The method according to claim 1, wherein said step (c) further includes checking if the player holds the playing license that should be revoked, if it holds, it is not allowable for the player to play the compact disc normally.

3. The method according to claim 1, further including the following steps:
If revoke all the relevant playing license, confirm whether the player holds legal authorization;
If the player holds legal authorization, update the system software of the copy protection thereof.

4. The method according to claim 1, wherein said step a) further includes the step of reading said version number from the said compact disc.

5. The method according to claim 3, further including the step of downloading needed new system software of the copy protection from the Internet.

6. The method according to claim 3, further including the step of downloading needed new system software of the copy protection from compact disc or floppy disk.

7. The method according to claim 3, wherein said updating step includes updating the software of the bus encryption module of said player and updating the software of the bus decryption module and revocation conformation module in the decoding part of said player.

8. The method according to claim 1, wherein the confirming step of said step c) is implemented by the ID conformation module in the decoding part in said player.

9. The method according to claim 4, wherein said disk includes a guiding area, in the second sector of which are encrypted disk keys that are 16 bytes or over and the 16 bytes information on the version number of the system for the copy protection.

10. A player of increasing the extendibility of disk copy protection, it includes a drive part and a decoding part, said drive part includes an authentication module, a bus encryption module and an ID confirmation module; said decoding part includes an authentication module, a bus decryption module, a revocation confirmation module and an ID confirmation module, wherein,
When said player judges it needs to revoke all the relevant playing license according to the information of revocation data in said played compact disc, the ID confirmation module in said drive part, updating the software of the bus encryption module of the driving part, firstly confirms whether the player holds legal authorization, if it holds, update the software of the bus decryption module and update the software of the bus decryption module and revocation confirmation module in the decoding part;
When the said player needs to implement revoking the partial relevant playing license, the revocation confirmation module in the decoding part receives revocation data read from the compact disc and confirms revoking partial revocation data.

11. The player according to claim 10, wherein said read software is downloaded from the Internet.

12. The player according to claim 10, wherein said read software is read from upgraded optical compact disc or floppy disk.
